(19) United States
(12) Patent Application Publication
(10) Pub. No.: US 2004/0204623 A1
(43) Pub. Date: Oct. 14, 2004

(54) Method of treatment

(76) Inventors: Derek William Anderson, Salisbury (GB); Richard James Soilleux, Salisbury (GB)

Correspondence Address: JOHN S. PRATT, ESQ, KILPATRICK STOCKTON, LLP, 1100 PEACHTREE STREET, ATLANTA, GA, 30309, US

(21) Appl. No.: 10/478,224

(22) PCT Filed: May 21, 2002
(86) PCT No.: PCT/GB02/02376

(30) Foreign Application Priority Data
May 21, 2001 (GB) 0112216.7

(51) Int. Cl. A62D 3/00

(52) U.S. Cl. 588/200

(57) ABSTRACT

Method for treating a composition containing (a) a chemically toxic material, typically containing a toxic metal and/or (b) an energetic, typically explosive, material, comprising (i) forming an aqueous dispersion of the composition; (ii) adding an inert absorbent material such as a clay; and (iii) heating so as to degrade the material (a) and/or (b) to a less hazardous form. The product is an inert matrix in which the hazardous materials (a) and/or (b) are dispersed, ideally in a sufficiently well bound form as to prevent leaching on subsequent long-term storage.

### FIELD OF THE INVENTION

This invention relates to the treatment of hazardous materials, in particular compositions including an energetic (such as an explosive) material and/or a toxic material.

### BACKGROUND OF THE INVENTION

The treatment of hazardous materials, to render them “safe” for subsequent storage or disposal, has long created problems in both industry and defence. Particularly problematic are compositions containing toxic elements such as arsenic, cadmium, chromium, mercury, tin, lead, selenium or tellurium. Such compositions may be the by-products of industrial processes, for example mining, or they may be present in unused or spent munitions, in particular chemical warfare (CW) munitions.

Methods which can otherwise be used to render toxic chemicals safe, for instance involving reagents such as oxidising or hydrolysing agents (base hydrolysis is known, for example, to treat CW agents), tend to be inadequate when a toxic element is present, since the toxic element always remains in some form even after treatment. It has therefore become common to encapsulate such compositions in a suitable inert matrix, usually after some form of chemical treatment, to allow their safe handling and storage. Encapsulants include glass (“vitrification”) and, though less effective, concrete or bitumen.

Other problematic materials which again are typically present in disused munitions, are the energetic materials such as explosives. It can be extremely difficult to render such materials safe. Known treatment techniques are hazardous, particularly on a large scale, and require special equipment such as—for instance for controlled incineration—armoured incinerators with high explosive capacity. Encapsulation techniques such as vitrifcation are unsuitable because of the amount of solid handling they involve, and because of the high risk of detonation during the melting step.

Most problematic of all are mixtures of energetic materials and toxic chemicals. Disused CW munitions typically contain such mixtures. In this case there is no truly acceptable treatment method; incineration to deal with the energetic material could be extremely hazardous and could result in toxic fumes which would need to be chemically “scrubbed” before release into the environment, whereas the instability of the energetic material brings handling difficulties which make conventional chemical treatment processes, such as base hydrolysis and vitrification, unsuitable—base hydrolysis, for instance, will dissolve the explosive TNT, but will form other explosive compounds in the process.

It would be desirable to provide alternative treatment processes to render safe, for subsequent handling, storage and/or disposal, compositions of the type described above, in particular those containing both energetic and chemically toxic materials.

### STATEMENTS OF THE INVENTION

According to a first aspect of the present invention there is provided a method for the treatment of a composition containing (a) a chemically toxic material and/or (b) an energetic material, the method comprising the steps of:

(i) forming an aqueous dispersion of the composition;

(ii) adding to the dispersion an inert absorbent material; and

(iii) heating the resultant mixture so as to degrade the material (a) and/or (b) to a less hazardous form.

By “treatment” of the composition is meant a process which renders the composition less hazardous, for instance more stable or less toxic. Ideally the treatment renders the composition non-hazardous, preferably sufficiently safe as to allow its subsequent handling without special precautions. More preferably the treatment renders the composition sufficiently safe and stable as to be suitable for long-term storage in the environment, for instance in a landfill site.

The method of the invention conveniently forms part of a process for the disposal of a hazardous composition. The composition may be, for example, a by-product of an industrial process, a munition or pyrotechnic or part thereof, or a fuel or propellant material.

This method may be used to treat a composition containing either one or more materials of type (a) or one or more materials of type (b), although it is particularly suited for treating compositions which contain both types (a) and (b) and which are therefore difficult to treat using conventional methods. The treatment steps (i) and (ii) allow both types of hazardous materials to be dispersed throughout an inert matrix which can then be safely handled.

An advantage of the method of the invention is thus that it may be used to treat a range of different hazardous materials or mixtures thereof. More importantly, it may in certain cases be used to treat compositions of which the exact nature of the constituents is unknown. This is likely to be of particular value in dealing with CW munitions, the contents of which can be difficult to separate.

The method of the invention can provide a relatively simple, rapid, safe and efficient treatment method for compositions of the type referred to. It draws on simple laboratory techniques and readily available equipment and reactants, and can thus lend itself to scale-up. This is important for use in industry but particularly for the disposal of CW munitions, of which there are currently large quantities throughout the world.

The method may be carried out directly on the waste stream from another treatment process such as base hydrolysis. In this way the waste stream may be made safe if it contains toxic elements. Thus, the method of the invention may comprise the additional step, prior to step (i), of subjecting the composition to a chemical treatment with one or more reactants capable of rendering the material (a) and/or (b) less hazardous, in particular subjecting the composition to hydrolysis suitably in the presence of a base.

According to a second aspect of the invention, there is provided a method for the treatment of an unused or spent CW munition containing (a) a chemically toxic material, typically containing a toxic metal, and/or (b) an energetic, typically explosive, material, the method comprising the steps of:

(1) opening the munition;

(2) subjecting its contents to a chemical treatment (such as base hydrolysis) with one or more reactants capable of rendering the material (a) and/or (b) less hazardous;

(3) forming an aqueous dispersion of the thus treated contents;

(4) adding to the dispersion an inert absorbent material; and

(5) heating the resultant mixture so as to degrade the material (a) and/or (b) to a less hazardous form.

The munition opening step (1) may be carried out by any known means, such as mechanical or water jet cutting or cryofracture.

The methods of the invention may involve the further step, following step (iii)/(5), of drying the mixture of the aqueous dispersion and the absorbent material, for instance to form a thick slurry or more preferably a solid. This can then be disposed of (for example, in a landfill site) in the form of for instance appropriately dimensioned bricks or blocks. Drying and/or cooling are thus conveniently carried out in an appropriately shaped mould and may involve pressing, moulding or otherwise shaping the product into a desired form. In some cases, depending on the nature of the absorbent material used, the product may be a malleable as opposed to a rigid solid.

The methods of the invention result in a single handleable product. This is an inert matrix containing, dispersed and entrapped therein (preferably uniformly dispersed throughout the matrix), the hazardous materials of type (a) and/or (b) from the original composition or at least the hazardous components of those materials. The matrix is generally environmentally stable, ie, it does not suffer from significant leaching of the entrapped materials on long term storage in the environment.

In a composition to be treated the present invention, the chemically toxic material (a) typically contains a toxic chemical element, more typically a metal such as a heavy metal. Examples include arsenic, cadmium, chromium, mercury, tin, lead, selenium and tellurium, in particular arsenic which is found in many CW agents and which is toxic in all forms to all organisms. The material (a) may be an organometallic material in which a toxic metal is complexed with organic moieties. Typical examples of (a) include the by-products of mining (eg, gold, tin or lead mining) processes, and CW agents. Such CW agents include CG (phosgene), H (sulphur mustard), white phosphorous, Lewisite (dichloro(2-chloro-vinyl arsine), DM/Adamsite (diphenylaminechloroarsine), DA (diphenylchloroarsine) and DC (diphenylcyanoarsine).

Other materials (a) include inorganic compounds such as oxides, acids and salts containing toxic metals, examples being arsenic trioxide or pentoxide, arsenic acid and its salts. The material (a) may additionally or alternatively include a toxic metal in its free, atomic, form. It may be a product of a previous chemical treatment of a toxic material, for instance thiodiglycol (TDG) obtained from the hydrolysis of sulphur mustard.

The energetic material (b) is typically an explosive or similarly unstable material such as TNT (2,4,6-trinitrotoluene). RDX (1,3,5-trinitrotriazine), picric acid (2,4,6-trinitrophenol) or a derivative of picric acid such as the unstable picrates which can be formed on deterioration of the acid. Such materials can often be extremely sensitive to shock and/or movement, and even sometimes to particle size (“grit sensitisation”), making them very difficult to handle. Picric acid is especially hazardous when dry; its incorporation into an aqueous dispersion in accordance with the invention therefore greatly facilitates its safe treatment.

The absorbent material added in step (ii)/(4) ideally has a high available surface area over which to absorb components of the aqueous dispersion formed during step (i)/(3). It is therefore preferably in a finely divided form such as a granulate or more preferably a powder. Suitable particle sizes might be in the range 1 to 20 μm, preferably between 2 and 15 μm, more preferably between 2 and 10 or between 8 and 15 μm, for instance about 10 μm. However, where the composition to be treated contains an energetic material which is vulnerable to grit sensitization, it may be appropriate to restrict the particle size of the absorbent material to 10 μm or less, preferably 5 μm or less, more preferably 2 μm or less as in clays.

The amount of absorbent material added to the aqueous dispersion depends on the loading of the hazardous materials (a) and/or (b) required in the final product, on the nature of the absorbent material itself and also (often more importantly) on the consistency required of the mixture for subsequent processing, for instance for the heating step (ii)/(5). Suitably between 20 and 90% w/v of the absorbent material may be added to the aqueous dispersion of step (i)/(3). If the resultant mixture is to be transferred directly to a crucible for the heating step (iii)/(5), then suitably between 40 and 90% w/v, more preferably between 55 and 85% w/v, of the absorbent material may be added to the dispersion. Generally one would seek to minimise, subject to the above, the amount of the absorbent material added, so as to reduce the volume of the final product, whilst also maximising (within acceptable safety limits) the amount of hazardous material it absorbs.

Examples of suitable absorbent materials include clays of all types, concrete, cement and mixtures thereof. These materials are porous. Many of them are widely available and relatively inexpensive. Particularly preferred are clays, preferably montmorillonites, a readily available example being “Fuller's Earth”. Concrete may be less preferred for the treatment of energetic materials, if there is a risk of grit sensitisation.

The absorbent material functions as a solid diluent for the composition being treated, and also as a moderator for energetic materials present in it, allowing their safe subsequent processing for instance by heat treatment. Thus, during step (iii)/(5), any energetic material (b) should be sufficiently well dispersed throughout the absorbent material that it will degrade upon heating rather than exploding, detonating or deflagrating.

The aim of step (i)/(3) in the methods of the invention should be to create as uniform as possible a dispersion of the composition in water. The dispersion may be in the form of a solid suspension or slurry, or more preferably of an emulsion in which at least one of the hazardous materials (a) and/or (b) is in a liquid form. Ideally any water-soluble constituents of the composition should be completely dissolved during step (i)/(3), again to maximise their dispersion.

To enhance dispersion the mixture of water and the composition to be treated is preferably agitated, more preferably rapidly agitated, and preferably heated so as to increase the solubility of (a) and/or (b) and/or to render at least some, suitably all, of them liquid. Suitably the dispersion is heated to at least 40, preferably 50, more preferably 80° C., at which many organometallic materials of type (a) will begin to melt, It may be heated up to as high as its boiling point (ie, at atmospheric pressure, up to 95, 98, 99 or even 100° C.)—at these higher temperatures, explosive materials such as TNT (melting point 80° C.) will also start to melt. The heating and/or agitation are preferably carried out for a sufficient period of time to form a homogeneous, ideally clear, mixture of the components present, with the soluble components dissolved and the insoluble ones thoroughly dispersed.

To further enhance solubility of the materials (a) and/or (b), in particular (a), a pH-adjusting agent may be added to the dispersion. Many toxic metal-containing CW agents, for instance, may be solubilised by higher pHs, so a water-soluble base may be added to the dispersion. Suitable such bases are the inorganic ones, in particular alkali metal hydroxides such as sodium or potassiun hydroxide.

Other materials, such as complexing agents, which serve to enhance the aqueous solubility of the materials (a) and/or (b) may also be included in step (i)/(3). Emulsifying agents, surfactants and the like may be added to further aid the formation of a uniform dispersion—suitably such materials may be added in amounts of between 0.2 and 5% w/w, preferably between 0.5 and 4% w/w, more preferably between 1 and 3% w/w.

Within the aqueous dispertion, the concentration of the composition to be treated should be as high as possible to allow more efficient processing, whilst also being sufficiently low as to allow proper dispersion of the components and safe handling of the energetic material (b). Suitably the dispersion might contain between 0.5 and 30% w/v, preferably between 1 and 25% w/v, more preferably between 5 and 20% w/v or between 5 and 15% w/v or between 5 and 10% w/v of the chemically toxic material (a), and/or between 0.5 and 20% w/v, preferably between 1 and 15% w/v, more preferably between 5 and 15% w/v of the energetic material (b), although this will naturally depend on the nature of the hazardous material(s) present.

The absorbent material is preferably, although not necessarily, added whilst the aqueous dispersion of step (i)/(3) is still hot, for instance at greater than 40 or 50° C., preferably at between 40 and 99° C., or between 50 and 98° C., such as at about 95° C. A suitable temperature is generally at or above the melting point of one or more (ideally all) of the hazardous materials present, for instance 80° C. or above, or 85° C. or above, or 90° C. or above.

The heating step (iii)/(5) has the primary objective of pyrolysing or “mineralising” the organic materials present, although it is also helpful to drive off water and thus reduce the volume of the final product, and may also serve to make the product more robust structurally. It may be carried out directly on the mixture formed in step (ii)/(4) or on a pre-dried, pre-solidified form thereof.

Such a pyrolysis would generally be unsafe for a composition containing an energetic material of type (b). Dispersion of the material throughout a solid matrix, as in step (ii)/(4) of the invented methods, renders it possible.

The temperature needed depends on the materials present, but is suitably above 200° C. and might typically be between 300 and 500° C., preferably about 400° C. or greater. The variation in temperature with time during step (iii)/(5) will also depend on the materials present and on the physical form of the mixture being heated—if the mixture is a solid, then its size and surface area are important since overly rapid heating can cause structural damage due to steam generated within it. The increase in temperature may follow any desired profile; it may for example be continuous or stepped or a mixture of both. It has been found, by way of example, that a 1 inch³ block containing an arsenic-containing CW agent and TNT in about 20 or 30 g of clay may be heated continuously from room temperature to 400 °C. over a period of greater than 30 minutes, preferably about an hour, to achieve pyrolysis.

Oxygen should be present during this heating step, although sufficient quantities may already be present within the absorbent matrix. Gaseous products such as SOₓ and NOₓ may be evolved and require cleaning, for instance using caustic scrubbers, and scrubber brines may be recycled to step (i)/(3) of the methods of the invention.

Following step (iii)/(5), the composition may be further heated so as to vitrify it, thus trapping the hazardous elements in a highly unleachable form. Suitable temperatures for this step may be between 700 and 1000° C. Direct vitrification of a mixture containing an energetic component would be inappropriate, but the present invention enables the subsequent use of vitrification as an additional level of safety when treating such mixtures, of particular use when highly toxic chemicals are present.

At any stage during a method according to the invention, in particular in or before step (i)/(3), or during step (ii)/(4), reagents may be introduced which help to reduce the hazardous nature (eg, the toxicity, reactivity or instability) of materials present in the composition being treated. Such reagents may for instance form chemical complexes with hazardous materials, convert them into less toxic oxidations states or physically immobilise them. For example, where the composition contains a material of type (a) including arsenic, an alkaline-earth metal-containing reagent (eg, a calcium compound such as calcium hydroxide or calcium peroxide) is ideally present during at least a part of the treatment process, since this will form calcium arsenate salts in which the arsenic is present in its slightly less toxic pentavalent form rather than the trivalent form. This type of reagent may suitably be added with the absorbent material in step (ii)/(4); in this case, it may assist the precipitation of certain species from the aqueous dispersion

Alkali and alkaline earth metals may, when present in the correct proportions and under the correct conditions of temperature and pressure, also combine with silica introduced in the absorbent material to form a glass.

A third aspect of the present invention provides the use of an inert absorbent material of the type described in connection with the first aspect, in the treatment of a composition containing (a) a chemically toxic material, typically containing a toxic metal and/or (b) an energetic, typically explosive, material. Such use preferably involves adding the absorbent material to an aqueous dispersion of the composition. More preferably it forms part of a method according to the first or second aspect of the present invention.

According to a fourth aspect, the invention provides a product comprising a matrix of an inert absorbent material in which is dispersed (a) a chemically toxic material and/or a pyrolysed form thereof, typically containing a toxic metal, and/or (b) an energetic, typically explosive, material and/or a pyrolysed form thereof. The absorbent material, and the materials (a) and/or (b), may be as described above in connection with the first aspect of the invention. The product of the fourth aspect is preferably environmentally stable and non-hazardous, so as to be suitable for long-term storage (desirably for many tens or even hundreds of years, preferably at least 50 or 100 or 200 years) in the environment. The materials (a) and/or (b) are preferably contained within the matrix in a sufficiently well bound form that they will not to any significant degree leach out on subsequent long-term storage for instance underground in a landfill site.

The product of the fourth aspect of the invention may conveniently be made using a method according to any one of the first to third aspects.

The present invention will now be described by way of example only, with reference to the following non-limiting examples.

### EXAMPLE 1

### Disposal of the Explosive 2,4,6-tritrotoluene (TNT)

An aqueous slurry (ca 5% w/v) of TNT was prepared by the addition of deonised water (10 ml) to a pre-weighed sample of flaked TNT (0.505 g). The slurry was made up to 25 ml with deionised water and the temperature increased to 85 °C. (water bath) with constant stirring.

After stirring at this temperature for a further 10 minutes, Fuller's Earth was slowly added in four aliquots (2.03 g, 2.56 g, 2.47 g and 2.53 g). Stirring was continued for 30 minutes while the vessel was allowed to cool to room temperature. A further amount of the clay (10.18 g) was then added.

After thorough mixing the entire contents of the flask were transferred to a metal crucible and placed within a muffle furnace. The temperature within the furnace was raised to 400° C. and this temperature maintained for one hour, after which the crucible was removed and the contents allowed to cool to room temperature.

An aliquot of the product was extracted with Analar® acetone and this solution compared with an authentic sample of TNT in Analar® acetone (0.25 mg ml⁻¹) by thin layer chromatography (TLC) on silica plates. The mobile phase used for elution was hexane:acetone (58:42) and the plates were visualised under ultraviolet (UV) illumination (wavelengths 254 and 365 nm). There was no evidence for the presence of TNT in the sample from the furnace. This indicates efficient disposal of the explosive using the method of the present invention.

### EXAMPLE 2

### Disposal of the Toxic Chemical Warfare (CW) Agent Diphenylcyanoarsine (DC)

An aqueous slurry (ca 3.6% w/v) of diphenylcyanoarsine (DC) was prepared by the addition of deionised water (15 ml) to a pre-weighed sample of DC (0.54 g). The slurry was transferred to a water bath and the temperature increased to 65° C. with constant stirring.

After stirring at this temperature for a further 10 minutes, Fuller's Earth was slowly added in three aliquots (3.07 g, 3.56 g and 5.31 g). Stirring was continued for 30 minutes while the vessel was allowed to cool to room temperature.

After thorough mixing the entire contents of the flask were transferred to a metal crucible and stored at room temperature overnight. The crucible was then placed within a muffle furnace and the temperature raised to 400° C. This temperature was maintained for one hour, after which the crucible was removed and the contents allowed to cool to room temperature.

An aliquot of the product was extracted with Analar® acetone and this solution compared with an authentic sample of DC in Analar® acetone by thin layer chromatography (TLC) on silica plates. The mobile phase used for elution was hexane:acetone (58:42) and the plates were visualised under ultraviolet (UV) illumination (wavelengths 254 and 365 nm). There was no evidence for the presence of DC in the sample from the furnace.

### EXAMPLE 3

### Disposal of a Mixture of TNT and Diphenylcyanoarsine (DC)

An aqueous slurry of TNT (ca 2.5% w/v) and DC (ca 2% w/v) was prepared by the addition of deionised water (10 ml) to a pre-weighed sample of DC (0.41 g) and addition of this mixture to a pre-weighed sample of flaked TNT (0.501 g) in deionised water (10 ml). The slurry was transferred to a water bath and the temperature increased to 85° C. with constant stirring.

After stirring at this temperature for a further 20 minutes the clay (Fuller's Earth) was slowly added in four aliquots (3.1 g, 2.8 g, 3.1 g and 2.6 g). Stirring was continued for 30 minutes while the vessel was allowed to cool to room temperature.

After thorough mixing the entire contents of the flask were transferred to a metal crucible and stored at room temperature overnight. The crucible was then placed within a muffle furnace and the temperature raised to 400° C. This temperature was maintained for 90 minutes, after which the crucible was removed and the contents allowed to cool to room temperature.

An aliquot of the product was extracted with Analar® acetone and this solution compared with authentic samples of TNT in Analar® acetone and DC in Analar® acetone by thin layer chromatography (TLC) on silica plates. The mobile phase used for elution was hexane:acetone (58:42) and the plates were visualised under ultraviolet (UV) illumination (wavelengths 254 and 365 nm). There was no evidence for the presence of either TNT or DC in the sample from the furnace.

1. Method for the treatment of a composition containing (a) a chemically toxic material and (b) a material which is either explosive or is sensitive to shock and/or movement and/or particle size, the method comprising the steps of:
(i) forming an aqueous dispersion of the composition;
(ii) adding to the dispersion an inert absorbent clay; and
(iii) heating the resultant mixture so as to degrade the material (a) and/or (b) to a less hazardous form.

2. Method according to claim 1, comprising the additional step, prior to step (i), of subjecting the composition to a chemical treatment with one or more reactants capable of rendering the material (a) and/or (b) less hazardous.

3. Method for the treatment of an unused or spent chemical warfare munition containing a composition which includes (a) chemically toxic material and (b) a material which is either explosive or sensitive to shock and/or movement and/or particle size, the method comprising the steps of:
(1) opening the munition;
(2) subjecting its contents to a chemical treatment with one or more reactants capable of rendering the material (a) and/or (b) less hazardous;
(3) forming an aqueous dispersion of the thus treated contents;
(4) adding to the dispersion an inert absorbent clay; and
(5) heating the resultant mixture so as to degrade the material (a) and/or (b) to a less hazardous form.

4. Method according to claim 2, wherein the chemical treatment involves subjecting the composition to hydrolysis in the presence of a base.

5. Method according to claim 1, wherein the composition is a by-product of an industrial process, a munition or pyrotechnic or part thereof or a fuel or propellant material.

6. Method according to claim 1, involving the further step, following step (iii), of drying the mixture of the aqueous dispersion and the clay to form a slurry or solid.

7. Method according to claim 6, wherein the drying step involves pressing, moulding or otherwise shaping the mixture into a desired form.

8. Method according to claim 1, wherein the chemically toxic material (a) contains a toxic element.

9. Method according to claim 8, wherein the toxic element is a metal.

10. Method according to claim 8, wherein the toxic element is selected from the group consisting of arsenic, cadmium, chromium, mercury, tin, lead, selenium, tellurium and mixtures thereof.

11. Method according to claim 10, wherein the toxic element is arsenic.

12. Method according to claim 1, wherein the material (a) is a chemical warfare (CW) agent.

13. Method according to claim 12, wherein the CW agent is selected from the group consisting of phosgene, sulphur mustard, white phosphorous, dichloro(2-chloro-vinyl)arsine, diphenylaminechloroarsine, diphenylchloroarsine, diphenylcyanoarsine and mixtures thereof.

14. Method according to claim 1, wherein the material (b) is an explosive.

15. Method according to claim 14, wherein the material (b) is selected from the group consisting of TNT (2,4,6-trinitrotoluene), RDX (1,3,5-trinitrotriazine), picric acid (2,4,6-trinitrophenol), a derivative of picric acid and mixtures thereof.

16. Method according to claim 1, wherein the clay added in step (ii) is in a finely divided form such as a granulate or powder.

17. Method according to claim 16, wherein the clay has a particle size of 10 μm or less.

18. Method according to claim 17, wherein the clay has a particle size of 2 μm or less.

19. Method according to claim 1, wherein step (ii), between 40 and 90% w/v of the clay is added to the aqueous dispersion.

20. Method according to claim 1, wherein the dispersion formed in step (i) is in the form of an emulsion in which at least one of the hazardous materials (a) and/or (b) is in a liquid form.

21. Method according to claim 1, wherein the composition is heated during step (i) so as to render at least one of the hazardous materials (a) and/or (b) liquid.

22. Method according to claim 21, wherein the composition is heated to at least 80° C. during step (i).

23. Method according to claim 1, wherein a pH-adjusting agent is added to the composition before or during step (i).

24. Method according to claim 23, wherein the pH-adjusting agent is a base.

25. Method according to claim 24, wherein the base is sodium or potassium hydroxide.

26. Method according to claim 1, wherein the aqueous dispersion formed in step (i) contains between 5 and 20% w/v of the chemically toxic material (a), and between 5 and 15% w/v of the explosive or sensitive material (b).

27. Method according to claim 1 wherein the clay is added whilst the aqueous dispersion of step (i) is at a temperature of 80° C. or greater.

28. Method according to claim 1, wherein the heating step (iii), is carried out at a temperature of 400° C. or greater.

29. Method according to claim 1, wherein following step (iii), the composition is further heated so as to vitrify it.

30. Method according to claim 1, additionally involving the introduction of a reagent which serves to reduce the hazardous nature of one or more materials present in the composition being treated.

31. Method according to claim 30, wherein the reagent is introduced with the clay in step (ii).

32. Method according to claim 30, wherein the reagent is introduced in or before step (i).

33. Method according to claim 30, wherein the reagent is calcium hydroxide or calcium peroxide.

34. Method for the treatment of a composition containing (a) a chemically toxic material and (b) a material which is either explosive or is sensitive to shock and/or movement and/or particle size, the method being substantially as herein described.

35. Use of an inert absorbent clay in the treatment of a composition containing (a) a chemically toxic material and (b) a material which is either explosive or is sensitive to shock and/or movement and/or particle size.

36. Use according to claim 35, which involves adding the clay to an aqueous dispersion of the composition to be treated.

37. Use according to claim 35, which forms part of a method according to claim 1.

38. A product comprising a matrix of an inert absorbent clay, in which is dispersed (a) a chemically toxic material and/or a pyrolysed form thereof, and (b) a material which is either explosive or is sensitive to shock and/or movement and/or particle size, and/or a pyrolysed form thereof.

39. A product according to claim 38, wherein the materials (a) and (b) are contained within the matrix in a sufficiently well bound form that they will not to any significant degree leach out on subsequent long-term storage.

40. A product according to claim 38, which has been made using a method according to claim 1.

41. Processs for the disposal of a composition containing (a) a chemically toxic material and (b) a material which is either explosive or is sensitive to shock and/or movement and/or particle size, the process involving carrying out a method according to claim 1.
